(19) United States
(12) Patent Application Publication
(10) Pub. No.: US 2012/0056438 A1
(43) Pub. Date: Mar. 8, 2012

(54) TRAILER DOOR STOP

(76) Inventor: Teresa Enderle, Trimble, MO (US)

(21) Appl. No.: 13/226,463

(22) Filed: Sep. 6, 2011

Related U.S. Application Data
(60) Provisional application No. 61/380,016, filed on Sep. 3, 2010.

(51) Int. Cl. E05C 3/04

(52) U.S. Cl. 292/194

(57) ABSTRACT

A trailer door stop comprising a base plate configured for mounting the door stop to a trailer door, a housing coupled to the base plate wherein the housing includes a vertically orientated slot, a spherical ball received into the housing and the ball is free to rotate within the housing, and a rod coupled to the ball and passing through the vertically orientated slot of housing. The rod is moveable in a substantially vertical direction within the vertically orientated slot of the housing. One embodiment includes the rod having a bend proximate its second end and wherein the bend is in close proximity to the location where the rod engages a ground surface. One embodiment includes the rod being pointed or beveled at the end where the rod engages the ground surface. The point may be defined by a single or multiple bevel of the surface of the rod.

### CROSS-REFERENCE TO RELATED APPLICATIONS

This application claims the benefit of U.S. Provisional Patent Application No. 61/380,016 having a filing date of Sep. 3, 2010 which is incorporated herein by reference to the extent permitted by law.

### BACKGROUND OF THE INVENTION

Trailers are used to haul merchandize, animals, livestock, personal property and any other items so desired. Many trailers have a single rear door that hinges on one side of the trailer and swings outwardly and away from the other side of the trailer. Other trailers may include two doors, each door hinged on the outer edge of the trailer that swings outwardly. Such trailer doors are well known in the art. Often, as the trailers or the doors get larger, the large doors may pose a hazard to users in that they are capable of swinging closed due to a gust of wind, gravity, or a spring assisted hinge mechanism. Larger trailers, in particular, have wide and often heavy doors and the angular velocity of the outer edge of the door as it swings shut can result in a forceful blow being applied to a user loading or unloading the trailer, merchandize or personal property, or even animals such as horses, cows, pigs, or other livestock. The momentum of the door may also provide a significant pinching force on a body located between the hinge and the outer edge of the trailer door. In such cases, if a user is unaware, the trailer door may begin to swing closed due to any number of causes and hit the user, animals, or the contents of the trailer, often causing injury or damage.

Further, trailers are pulled to various places and parked upon many different ground surfaces having varying physical properties. For example, trailers are often loaded or unloaded on a concrete parking lot or street, a pasture on a farm or a ranch, a gravel parking lot at the trailhead in a park, campgrounds, and many other locations having varying ground surfaces. Thus, having one door stop that is effective from keeping a door open that is equally effective on grass or dirt as it is on concrete has posed a significant obstacle in the art.

Thus, there is a need in the art for a door stop for a trailer door that is configured to be effective on virtually any ground surface to prevent a trailer door from unwantingly closing on a user, object, or animal.

### BRIEF SUMMARY OF THE INVENTION

The present invention is directed to a trailer door stop comprising a base plate having a front surface wherein the base plate is configured for mounting the door stop to the door of any type of trailer, such as utility, recreational, toy-haulers, livestock, or over-the-road. The trailer door stop of the present invention further includes a housing including a spacer having a first end, a second end, and an inner surface defining a first diameter. First end of the spacer is coupled to the front surface of the base plate. The housing further includes an end cap having a first end, a second end, and an inner surface defining the same first diameter as the spacer. The first end of the end cap is coupled to the second end of the spacer and the second end of the end cap is configured in a substantially semi-spherical shape configured to receive and house a ball. The second end of the end cap of the housing further includes a vertically orientated slot therethrough.

The trailer door stop of the present invention further includes a substantially spherical ball having an outer surface defining a second diameter wherein the second diameter is less than the first diameter defined by the housing. The ball is received into the housing such that a portion of the outer surface of the ball bears on a portion of the inner surface of the spacer and the inner surface of the end cap. The ball is free to rotate within the housing. The ball may include an aperture through the outer surface of the ball that extends radially a distance into the ball. The trailer door stop of the present invention further includes a rod coupled to the ball. The rod has a first end and a second end wherein the first end is configured to be received into the aperture defined in the ball and the second end is configured to engage a ground surface. The rod may further include a bend close to its second end that slightly alters the direction and magnitude of the frictional force applied to the ground surface. The second end of the rod may also include a point wherein the point may result from a single bevel or a bevel of multiple faces.

Other aspects and advantages of the present invention will be apparent from the following detailed description of the preferred embodiments and the accompanying drawing figures.

### BRIEF DESCRIPTION OF THE SEVERAL VIEWS OF THE DRAWING

The accompanying drawings form a part of the specification and are to be read in conjunction therewith, in which like reference numerals are employed to indicate like or similar parts in the various views, and wherein:

FIG. 1 is a side view of one embodiment of a trailer door stop in accordance with the teachings of the present invention;

FIG. 2 is a perspective view of a base plate of an embodiment of a trailer door stop in accordance with the teachings of the present invention;

FIG. 3 is an exploded side view of one embodiment of a trailer door stop in accordance with the teachings of the present invention;

FIG. 4 is a partial side view of one embodiment of a trailer door stop in accordance with the teachings of the present invention;

FIG. 5 is a partial side view of one embodiment of a trailer door stop in accordance with the teachings of the present invention;

FIG. 6 is a perspective view of one embodiment of a trailer door stop in accordance with the teachings of the present invention; and

FIG. 7 is a perspective view of one embodiment of a trailer door stop in accordance with the teachings of the present invention.

### DETAILED DESCRIPTION OF THE INVENTION

The following detailed description of the invention references the accompanying drawing figures that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

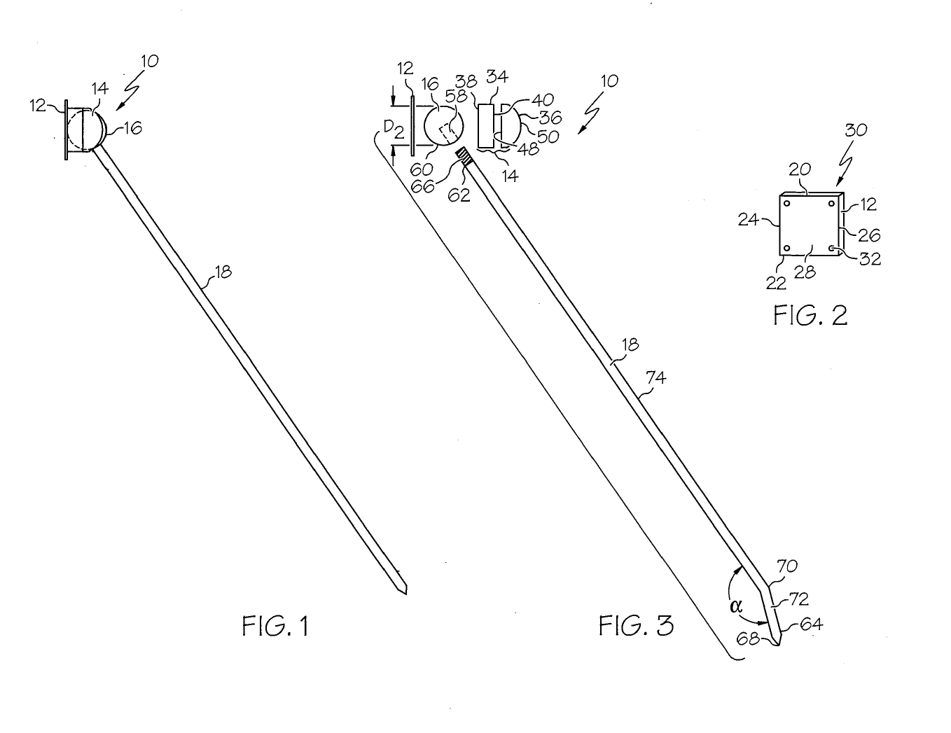

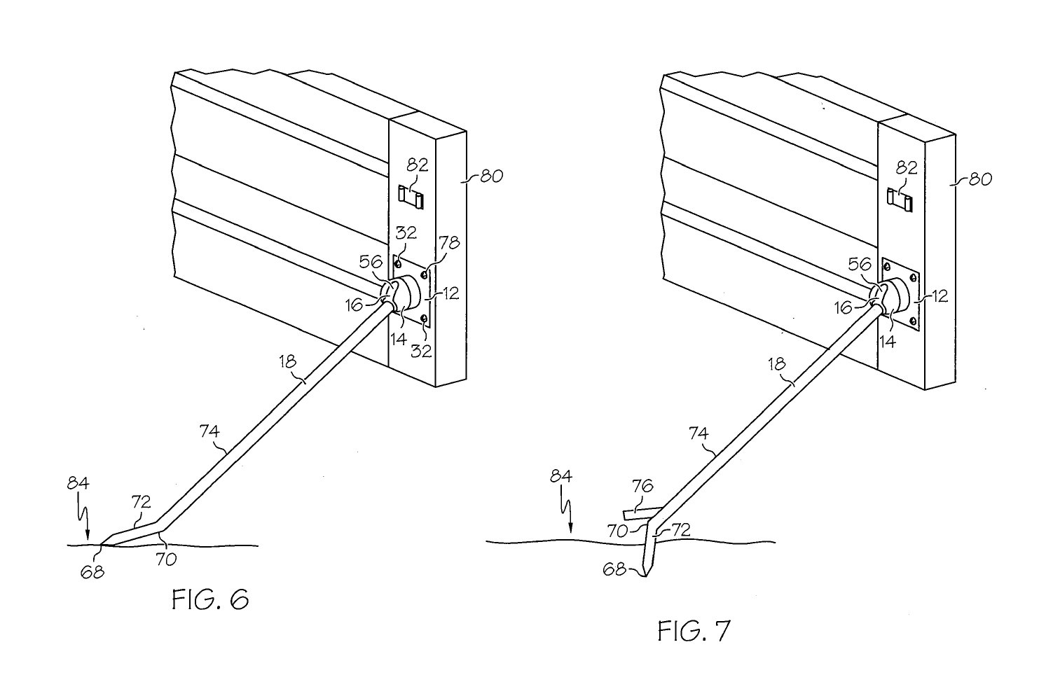

FIG. 1 illustrates an embodiment of a trailer door stop 10 of the present invention as assembled. As seen in FIG. 1, trailer door stop 10 includes a base plate 12, a housing 14, a ball 16 within housing 14, and a rod 18 extending outward from ball 16. FIG. 2 illustrates base plate 12 having a top 20, a bottom 22, a first side 24, a second side 26, a front surface 28 and a back surface 30. The thickness of base plate 12 is defined between front surface 28 and back surface 30. As shown, top 20, bottom 22, first side 24, and second side 26 generally define a rectangular or square shape. However, base plate 12 can be any shape now known or hereafter developed, including circular, triangular, or polygonal. Base plate 12 further includes a plurality of apertures 32 that are configured to facilitate fastening base plate 12 to a trailer door 80 (as shown in FIGS. 6 and 7). Base plate 12 may be any material now known or hereafter developed in the art having the desired strength characteristics including: metal, steel, stainless steel, brass, nickel, aluminum, titanium, thermoplastic, wood, carbon fiber, composites, fiberglass, or UHMW polyethylene, or any combination thereof.

Now turning to FIG. 3, housing 14 is shown including a spacer 34 and an end cap 36. A portion of end cap 36 includes a substantially semi-spherical shape configured to receive a spherical or ball-shaped object. Spacer 34 includes a first end 38 and a second end 40. End cap 36 includes a first end 48 and a second end 50. First end 48 of end cap 36 is configured to be coupled to second end 40 of spacer 34 to form housing 14 that receives ball 16 substantially closed at second end 50. First end 48 of end cap 36 may be coupled to second end 40 of spacer 34 through a spot or continuous weld, a threaded assembly or any other method now known or hereafter developed. Alternatively, an embodiment of the present invention not shown includes housing 14 having a one-piece construction and formed from one piece. FIG. 3 further illustrates housing 14 being configured to receive and cover ball 16, wherein ball 16 has an outer surface 60 that defines a diameter D₂.

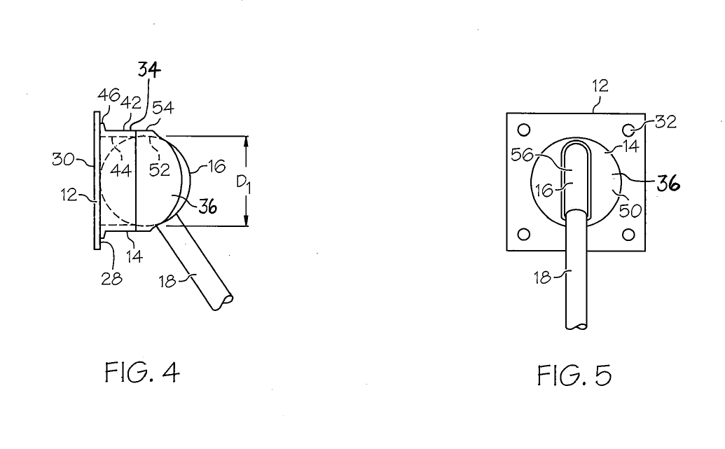

FIG. 4 illustrates an embodiment of the present invention wherein spacer 34 includes a substantially hollow, circular cross-section having an outer surface 42 and an inner surface 44. Outer surface 42 and inner surface 44 defines a thickness therebetween. Inner surface 44 defines diameter D₁. Similarly, end cap 36 of housing 14 includes an inner surface 52 and an outer surface 54 defining a thickness therebetween. Inner surface 52 also defines diameter D₁ proximate first end 48 of end cap 36. Further, spacer 34 may include a flange 46 proximate first end 38 that facilitates coupling housing 14 to base plate 12. Flange 46 may be any shape, including circular, and include a plurality of apertures (not shown) that receive fasteners therethrough to couple housing 14 to base plate 12. Further, flange 46 may be welded to base plate 12 to form a more permanent coupling. Alternatively, as shown in FIGS. 1 and 5, an embodiment of spacer 34 of housing 14 does not include flange 46 and, as such, outer surface 42 of first end 38 is welded or otherwise coupled directly to front surface 28 of base plate 12. In another embodiment (not shown), base plate 12 may include a threaded collar connected to its front surface 28 and spacer 34 may include a portion (not shown) of first end 38 being complimentary threaded. As such, housing 14 may be threadably coupled to base plate 12.

As shown in FIG. 5, second end 50 of end cap 36 includes a slot 56 therethrough. Slot 56 has a substantially vertical orientation as shown in FIG. 5 and may extend along a significant portion of the circumference of second end 50 of end cap 36. One embodiment includes a slot along a length substantially corresponding to a semi-circle. Another embodiment shown in FIG. 6 includes slot 56 being bell shaped having a larger opening proximate bottom 22 of base plate 12 than the opening proximate top 20 of base plate 12. A bell shaped slot 56 proves for some lateral movement of rod 18 when engaged with a ground surface thereby creating an internal mechanism to dampen the effect of a wind gust or other force applied to the trailer door that further assists door stop 10 in preventing unwanted movement of the trailer door. Housing 14 and spacer 34 and end cap 36 thereof may be fabricated by being extruded, rolled, pressed, machined, cast, punched, any other fabrication method now known or hereafter developed, or combination there of. Housing 14 may be any material now known or hereafter developed in the art having the desired strength characteristics including: metal, steel, stainless steel, brass, nickel, aluminum, titanium, thermoplastic, wood, carbon fiber, composites, fiberglass, UHMW polyethylene, or any other material now known or hereafter developed.

As best seen in FIG. 3, ball 16 has a substantially spherical shape having a diameter D₂. Diameter D₂ is less than diameter D₁. Ball 16 may be substantially solid having an aperture 58 through an outer surface 60 of ball 16 and aperture 58 extends a distance into ball 16 radially toward the center of ball 16. In another embodiment, ball 16 may also be hollow wherein outer surface 60 includes a material thickness. Aperture 58 may be threaded and configured to receive a threaded member. Another embodiment not shown may include ball 16 having a collar (not shown) coupled to outer surface 60 and extending radially outward therefrom wherein the collar is configured to receive rod 18. Ball 16 may be any material now known or hereafter developed including: metal, steel, stainless steel, brass, nickel, aluminum, titanium, thermoplastic, wood, carbon fiber, composites, fiberglass, nylon, UHMW polyethylene, or any combination thereof.

Rod 18 is an elongated piece of material of any cross-section known in the art. As shown in FIG. 2, rod 18 has a circular cross-section having a first end 62 and a second end 64. Rod 18 may be a solid bar or have a hollow cross-section and rod 18 may be any shape known in the art, with common shapes being circular, square, or rectangular. FIG. 2 illustrates an embodiment of the present invention including first end 62 of rod 18 being threaded and having threads 66 as shown. First end 62 of rod 18 may be inserted into and threadably engaged with aperture 58 of ball 16. Alternatively, first end 62 of rod 18 may be received into aperture 58 having a smooth bore and, as such, rod 18 may be coupled to ball 16 through an adhesive, weld, any other known coupling method, or any combination thereof. Further, the embodiment (not shown) wherein ball 16 includes a collar coupled thereto and rod 18 is received into the collar is within the scope of the present invention. The collar on ball 16 may or may not be threaded thereby facilitating coupling of rod 18 to ball 16 similar to the threaded assembly or other coupling methods described hereinabove.

As shown in FIG. 2, second end 64 of rod 18 may include point 68 defined by beveling one or more sides of second end 64 of rod 18. In addition, as shown in FIG. 2, one embodiment of rod 18 includes a bend 70 defining a transition between a point portion 72 of rod 18 and a body portion 74 of rod 18 wherein point portion 72 and body portion 74 intersect at an angle α. Angle α may be any angle known in the art, with one embodiment including angle α in a range between about one hundred (100) degrees and about one-hundred seventy nine (179) degrees. Angle α may be any angle known in the art, with one embodiment including angle α in a range between about one hundred fifty (150) degrees and about one-hundred seventy (170) degrees. A preferred embodiment includes an angle α of about one-hundred sixty (160) degrees. As shown in FIG. 7, rod 18 may include a step plate 76 coupled to body portion 74 proximate bend 70. Rod 18 may be any material including: metal, steel, stainless steel, brass, nickel, aluminum, thermoplastic, nylon, wood, carbon fiber, composites, fiberglass, UHMW polyethylene, or any other material now known or hereafter developed.

As shown in FIGS. 3 and 4, door stop 10 is assembled by ball 16 being received into housing 14. Inner surfaces 44 and 52 of housing 14 are configured at a diameter D₁, which is configured to be slightly larger than diameter D₂ of ball 16 thereby allowing ball 16 to rotate within housing 14. Outer surface 60 of ball 16 engages and bears against at least a portion of inner surfaces 44 and 52 of housing 14. Lubricant, such a grease or oil, may be used to reduce friction and wear between ball 16 and housing 14. Ball 16 may be constructed of, or have a outer layer of a material, like Teflon, nylon or UHMW polyethylene that have reduced friction characteristics. Housing 14 is coupled to base plate 12 enclosing ball 16 within housing 14. Rod 18 is then coupled to ball 16 such that rod 18 passes through slot 56. Alternatively, rod 18 may be previously coupled to ball 16 prior to ball 16 being inserted into housing 14 and, similarly, rod 18 will pass through slot 56 of housing 14.

FIGS. 6 and 7 show trailer door stop 10 in use. Trailer door stop 10 is coupled to a trailer door 80 as shown in FIGS. 6 and 7 such that slot 56 is in a substantially vertical direction. Fastener 78 is placed through apertures 32 and secured to trailer door 80 at a desired height above the ground. As shown in FIGS. 6 and 7, rod 18 passes through slot 56 and ball 16 is rotatably mounted within housing 14 such that rod 18 may be rotated in a substantially vertical direction within slot 56. When in transport, rod 18 may be secured in a substantially upward orientation by a rod holder 82. When the trailer door 80 is opened, rod 18 may be removed from rod holder 82 and rotated downward such that pointed portion 72 of rod 18 engages the ground surface 84. As shown in FIG. 6, pointed portion 72 of rod 18 may be positioned in a more horizontal orientation. This configuration provides for improved holding ability on harder surfaces as the combination of the point 68 and the angular orientation of pointed portion 72 at angle α provides a concentrated frictional force having both downward and horizontal components sufficient to secure door 80 at a desire position and more effectively resist door 80 from unwantingly closing. A bend angle α (shown in FIG. 3) of about one-hundred sixty (160) degrees has been found to provide optimal results. However, door stop 10 of the present invention has also been found to be effective with a substantially straight rod 18 as shown in FIG. 1.

As seen in FIG. 7, door stop 10 may also be orientated such that point portion 72 of rod 18 is in a more vertical orientation to contact ground surface 84. This orientation is particularly effective on soft surfaces like bare ground or warm asphalt. Rod 18 is rotated downward such that point 68 will penetrate ground surface 84. A user will push point 68 into ground surface 84 to secure door 80 and stop it from unwantingly closing. An embodiment of rod 18 may also include step plate 76 that assists the user in driving point 68 into ground surface 84. The configuration of rod 18 on door stop 10 of the present invention allows door stop 10 to be equally effective on both soft and hard ground surfaces.

From the foregoing, it may be seen that the component storage system of the present invention is particularly well suited for the proposed usages thereof. Furthermore, since certain changes may be made in the above invention without departing from the scope hereof, it is intended that all matter contained in the above description or shown in the accompanying drawing be interpreted as illustrative and not in a limiting sense. It is also to be understood that the following claims are to cover certain generic and specific features described herein.

I claim:

1. A trailer door stop comprising:
a base plate configured for mounting said door stop to a trailer door;
a housing coupled to said base plate, said housing including a vertically orientated slot;
a spherical ball received into said housing wherein said housing is configured to receive said ball and allow rotation of said ball within said housing and wherein said ball includes an aperture through an outer surface of said ball and extending radially a distance into said ball; and
a rod coupled to said ball and passing through said vertically orientated slot of said housing, said rod having a first end and a second end wherein said first end is configured to be received into said aperture of said ball and said second end includes a point, and wherein said rod is moveable within said vertically orientated slot of said housing.

2. The trailer door stop of claim 1 wherein a portion of an outer surface of said ball bears on a portion of an inner surface of said housing.

3. The trailer door stop of claim 1 wherein said rod includes a bend that defines a point portion and a body portion of said rod.

4. The trailer door stop of claim 3 wherein said bend is of a degree in a range from about one-hundred twenty (120) degrees to about one-hundred seventy nine (179) degrees.

5. The trailer door stop of claim 4 wherein said bend is of a degree in a range from about one-hundred fifty (150) degrees to about one-hundred seventy (170) degrees.

6. The trailer door stop of claim 5 wherein said bend is about one-hundred sixty (160) degrees.

7. The trailer door stop of claim 5 wherein said point of said rod is double beveled.

8. The trailer door stop of claim 3 wherein said rod further includes a step plate coupled to said body portion proximate said bend.

9. The trailer door stop of claim 1 wherein said vertical slot of said housing is bell shaped.

10. A trailer door stop comprising:
a base plate having a front surface, said base plate configured for mounting said door stop to a trailer door;
a housing including a hollow spacer having a first end, a second end, and an inner surface defining a first diameter, wherein said first end of said spacer is coupled to said front surface of said base plate, said housing further including an end cap having a first end, a second end, and a inner surface defining said first diameter, wherein said first end of said end cap is hollow and coupled to said second end of said spacer, and wherein said second end of said end cap is configured in a substantially semi-spherical shape and has a vertically orientated slot defined therethrough;
a substantially spherical ball having an outer surface defining a second diameter wherein said second diameter is less than said first diameter, wherein said ball is received into said housing such that a portion of said outer surface of said ball bears on a portion of said inner surface of said spacer and said inner surface of said end cap, wherein said ball is free to rotate within said housing, and wherein said ball includes an aperture through said outer surface of said ball extending radially a distance into said ball; and
a substantially straight rod coupled to said ball, said rod having a first end and a second end wherein said first end is configured to be received into said aperture of said ball and said second end is configured to engage a ground surface.

11. The trailer door stop of claim 10 wherein said rod further includes a step plate coupled proximate said second end.

12. The trailer door stop of claim 10 wherein second end further comprises a point that is double beveled.

13. The trailer door stop of claim 10 wherein said vertical slot of said housing is bell shaped.

14. A trailer door stop comprising:
a base plate having a front surface, said base plate configured for mounting said door stop to a trailer door;
a housing including a tubular spacer having a first end, a second end, and an inner surface defining a first diameter, wherein said first end of said spacer is coupled to said front surface of said base plate, said housing further including an end cap having a first end, a second end, and a inner surface defining said first diameter, wherein said first end of said end cap is coupled to said second end of said spacer, and wherein said second end of said end cap is configured in a substantially semi-spherical shape and includes a vertically orientated slot;
a substantially spherical ball having an outer surface defining a second diameter wherein said second diameter is less than said first diameter, wherein said ball is received into said housing such that a portion of said outer surface of said ball bears on a portion of said inner surface of said spacer and said inner surface of said end cap, wherein said ball is free to rotate within said housing, and wherein said ball includes an aperture through said outer surface of said ball and extending radially a distance into said ball; and
a rod coupled to said ball, said rod having a first end and a second end wherein said first end is configured to be received into said aperture of said ball and said second end includes a point wherein said rod is moveable within said slot of said housing, and wherein said rod includes a bend that defines a point portion and a body portion of said rod.

15. The trailer door stop of claim 14 wherein said point of said rod is double beveled.

16. The trailer door stop of claim 14 wherein said rod further includes a step plate coupled to said body portion proximate said bend.

17. The trailer door stop of claim 16 wherein said bend is of a degree in a range from about one-hundred fifty (150) degrees to about one-hundred seventy (170) degrees.

18. The trailer door stop of claim 17 wherein said bend is about one-hundred sixty (160) degrees.

19. The trailer door stop of claim 14 wherein said vertical slot of said housing is bell shaped.
